(19) United States
(12) Patent Application Publication
(10) Pub. No.: US 2024/0405589 A1
(43) Pub. Date: Dec. 5, 2024

(54) CONTROLLING METHOD OF CHARGING AND DISCHARGING DEVICE

(71) Applicant: SK On Co., Ltd., Seoul (KR)

(72) Inventors: Chang Mook HWANG, Daejeon (KR); Yea Eun KIM, Daejeon (KR); Gyeong Min RYU, Daejeon (KR); Sin Young MOON, Daejeon (KR)

(21) Appl. No.: 18/603,209

(22) Filed: Mar. 13, 2024

(30) Foreign Application Priority Data
Jun. 1, 2023 (KR) 10-2023-0070943

(51) Int. Cl. H02J 7/00

(52) U.S. Cl. CPC H02J 7/007194; H02J 7/0013; H02J 7/0049

(57) ABSTRACT

The present disclosure relates to a controlling method of a charging and discharging device, using a charging and discharging device including a plurality of units, wherein the units include a plurality of chambers accommodated in the units, wherein the chambers include a plurality of channels accommodated in the chambers, and wherein the channels charge or discharge secondary batteries, comprising: selecting a plurality of channels, each of which is connected to a secondary battery; and charging-and-discharging each of the secondary batteries connected to the selected plurality of channels, wherein the selecting a plurality of channels includes selecting the plurality of channels in a same unit.

### CROSS-REFERENCE TO RELATED PATENT APPLICATION

The present application claims priority under 35 U.S.C. § 119 (a) to Korean patent application number 10-2023-0070943 filed on Jun. 1, 2023, in the Korean Intellectual Property Office, the entire disclosure of which is incorporated by reference herein.

### BACKGROUND OF THE INVENTION

### 1. Field

The present relates to a controlling method of a charging and discharging device.

### 2. Description of the Related Art

The operating principle of secondary batteries, specifically lithium-ion batteries, is an oxidation-reduction reaction. In other words, secondary batteries are charged and discharged through the migration of lithium ions. When a secondary battery is discharged, lithium ions at an anode migrate to a cathode through an electrolyte and a separator. When a secondary battery is charged, lithium ions at a cathode anode migrate to an anode through an electrolyte and a separator.

Secondary batteries undergo a formation process during the manufacturing process. The formation process refers to a process in which an initially discharged secondary battery is repeatedly charged and discharged several times to form a solid electrolyte interphase (SEI) layer on an anode, thereby imparting electrical characteristics to the secondary battery and testing its discharge capacity.

The formation process is carried out in a charging/discharging device. A charging/discharging device includes a plurality of units. The units include a plurality of chambers. The chambers include a plurality of channels. Processes such as charging and discharging of a secondary battery is carried out in the channels.

Each process of the charging and discharging may end at different times due to differences in performance (capacity, resistance, etc.) of the secondary batteries being charged and discharged. As a result, the performance of a secondary battery connected to one channel may in some cases be adversely affected by a secondary battery connected to another channel. It is because when a secondary battery whose charging/discharging ends earlier at a first temperature proceeds to the next step at a second temperature that is a different temperature from the first temperature, charging/discharging of another secondary battery whose charging/discharging has not ended may be carried out at the second temperature.

### SUMMARY OF THE INVENTION

One object of the present disclosure is to efficiently carry out a controlling method of a charging and discharging device using a plurality of channels.

In addition, the present disclosure can be widely applied in the field of green technology, such as electric vehicles, battery charging stations, solar power generation, and wind power generation using batteries.

In addition, the present disclosure can be used in eco-friendly electric vehicles, hybrid vehicles, or the like to prevent climate change by suppressing air pollution and greenhouse gas emissions.

A controlling method of a charging and discharging device according to one embodiment of the present disclosure includes: selecting a plurality of channels, each of which is connected to a secondary battery, using a charging and discharging device including a plurality of units, wherein the units include a plurality of chambers accommodated in the units, wherein the chambers include a plurality of channels accommodated in the chambers, and wherein the channels charge or discharge secondary batteries; and charging-and-discharging each of the secondary batteries connected to the selected plurality of channels, wherein the selecting a plurality of channels includes selecting the plurality of channels in a same unit, and wherein the charging-and-discharging includes: first charging for fully charging all secondary batteries connected to the plurality of channels at a first temperature; first standing for allowing all the secondary batteries connected to the plurality of channels that have completed the first charging to stand at a second temperature; first discharging for fully discharging all the secondary batteries connected to the plurality of channels that have completed the first standing, at the second temperature; second standing for allowing all the secondary batteries connected to the plurality of channels that have completed the first discharging to stand at a third temperature; and second charging for fully charging all the secondary batteries connected to the plurality of channels that have completed the second standing, at the third temperature, wherein each step of the charging-and-discharging is simultaneously initiated in the plurality of channels.

The selecting a plurality of channels may further include selecting the plurality of channels in a same chamber.

The first charging may end simultaneously in the plurality of channels.

The first discharging may end simultaneously in the plurality of channels.

The second charging may end simultaneously in the plurality of channels.

The controlling method of a charging and discharging device may further include: determining a temperature change step for determining whether the first temperature and the second temperature are the same and whether the second temperature and the third temperature are the same in the charging-and-discharging by analyzing the temperature at which each step of the charging-and-discharging is carried out.

The first temperature may be different from the second temperature, and the first standing may be initiated simultaneously in the plurality of channels.

The first charging may end simultaneously in the plurality of channels.

The second temperature may be different from the third temperature, and the second standing may be initiated simultaneously in the plurality of channels.

The first discharging may end simultaneously in the plurality of channels.

The second charging may end at different times in the plurality of channels.

The second charging may be independently carried out in the plurality of channels.

According to one embodiment of the present disclosure, a controlling method of a charging and discharging device using a plurality of channels can be carried out efficiently.

### BRIEF DESCRIPTION OF THE DRA WINGS

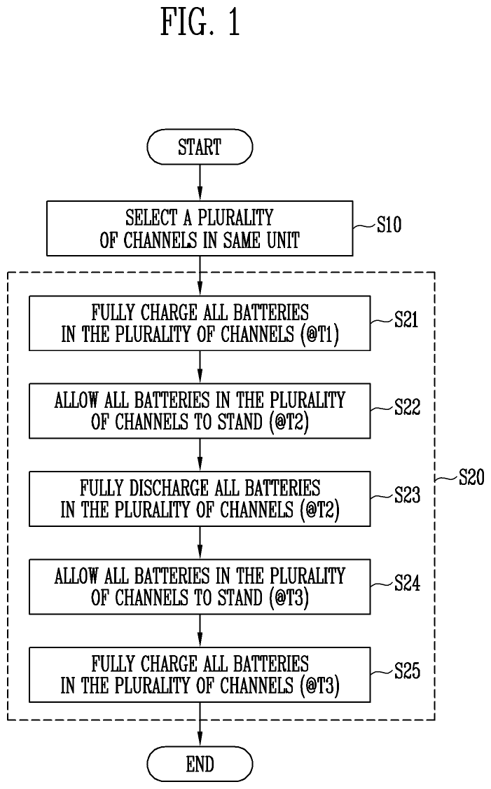

FIGS. 1 to 4 show flowcharts of embodiments of the present disclosure.

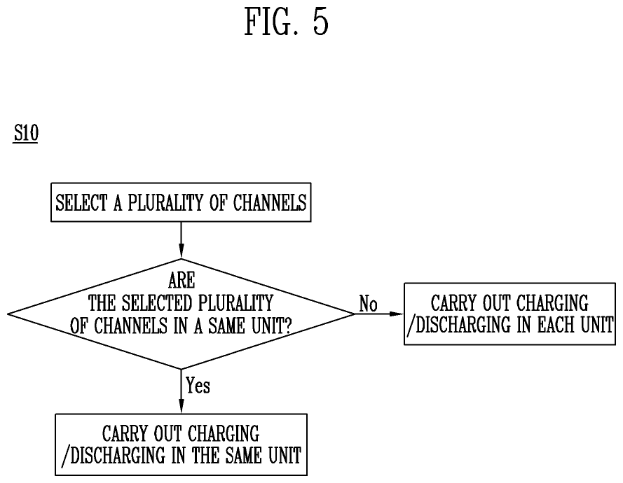

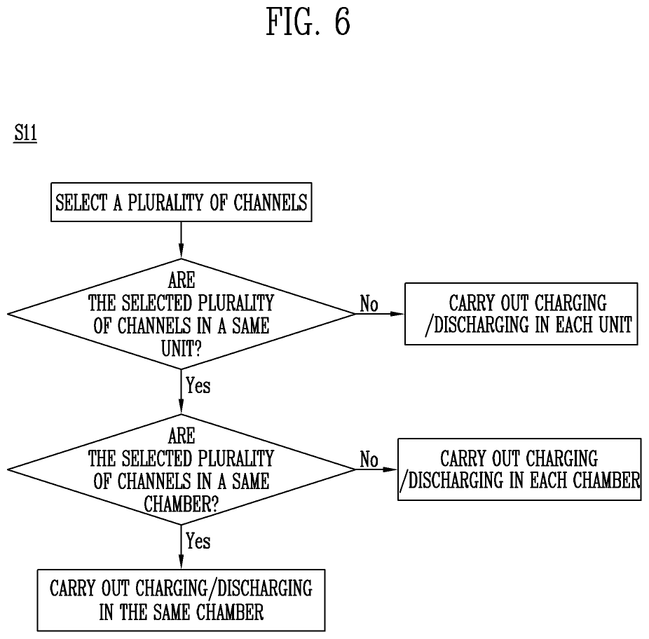

FIGS. 5 and 6 show flowcharts of selecting a plurality of channels in embodiments of the present disclosure.

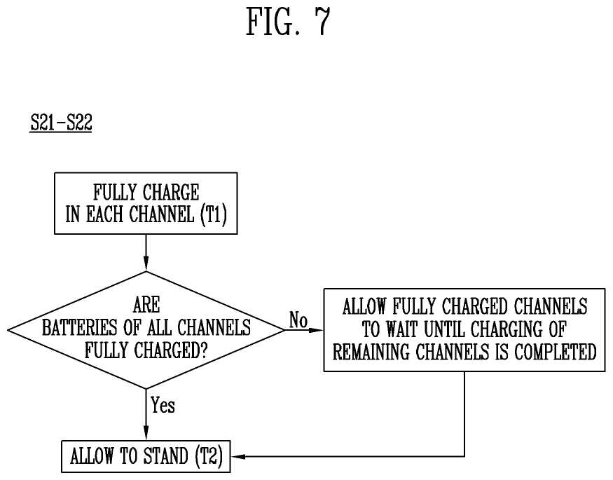

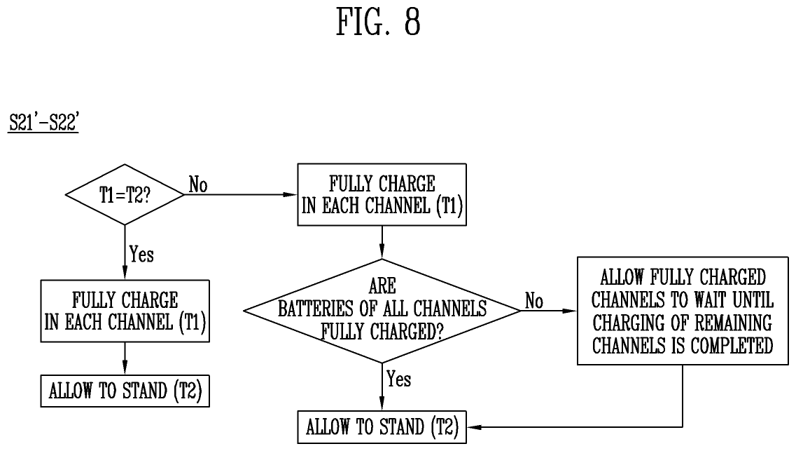

FIGS. 7 and 8 show flowcharts of first charging and first standing of an embodiment of the present disclosure.

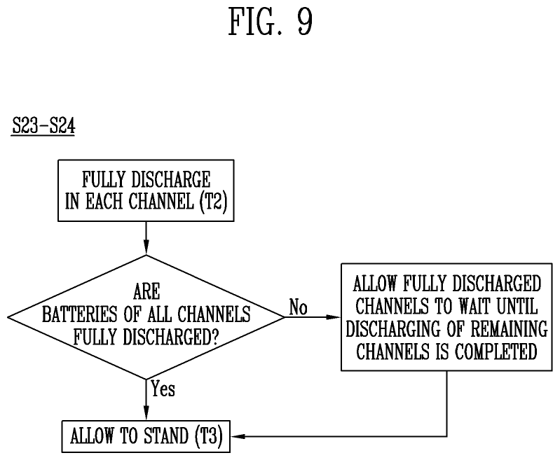

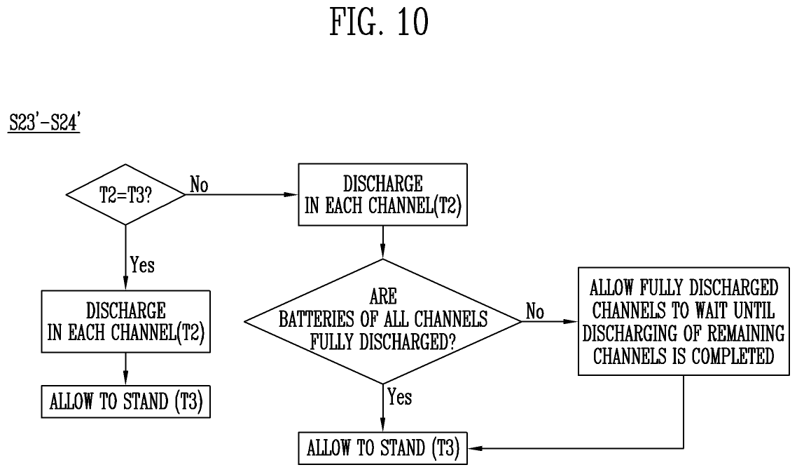

FIGS. 9 and 10 show flowcharts of first discharging and second standing of an embodiment of the present disclosure.

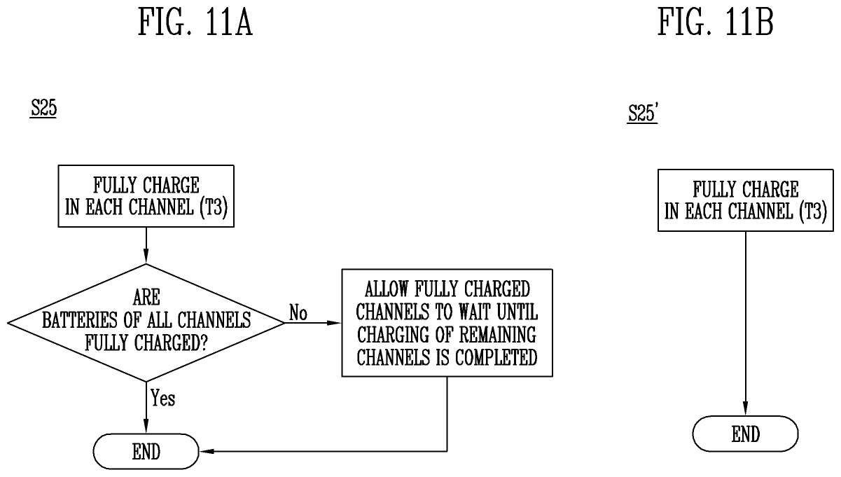

FIG. 11A and FIG. 11B show a flowchart of second charging of an embodiment of the present disclosure.

### DETAILED DESCRIPTION

Hereinafter, the present disclosure will be described in detail with reference to the attached drawings.

The present disclosure relates to a controlling method of a charging and discharging device. The present disclosure relates to a controlling method of a charging and discharging device using a charging and discharging device. The charging/discharging device includes a plurality of units. The units include a plurality of chambers accommodated in the units. The chambers include a plurality of channels accommodated in the chambers. The channels charge or discharge secondary batteries.

The controlling method of a charging and discharging device of the present disclosure includes: selecting S10, S11 a plurality of channels, each of which is connected to a secondary battery; and charging-and-discharging S20 each of the secondary batteries connected to the selected plurality of channels. The controlling method of a charging and discharging device of the present disclosure can carry out the selecting of a plurality of channels and charging-and-discharging S20 in a unique manner, thereby solving problems when charging/discharging of a secondary battery is carried out in a plurality of channels.

FIGS. 1 to 4 show flowcharts of embodiments of the present disclosure.

First, reference is made to FIG. 1. The selecting a plurality of channels includes selecting S10 the plurality of channels in a same unit. Specifically, in the selecting a plurality of channels, the plurality of channels within a same unit are selected so that the charging-and-discharging S20 is carried out in the plurality of channels within a same unit. When a plurality of channels within different units are selected, a charging/discharging process may be carried out in each unit.

The charging-and-discharging S20 includes first charging S21 for fully charging all secondary batteries connected to the plurality of channels at a first temperature T1. The charging-and-discharging S20 includes first standing S22 for allowing all the secondary batteries connected to the plurality of channels that have completed the first charging to stand at a second temperature T2. The charging-and-discharging S20 includes first discharging S23 for fully discharging all the secondary batteries connected to the plurality of channels that have completed the first standing, at the second temperature T2. The charging-and-discharging S20 includes second standing S24 for allowing all the secondary batteries connected to the plurality of channels that have completed the first discharging to stand at a third temperature T3. The charging-and-discharging S20 includes second charging S25 for fully charging all the secondary batteries connected to the plurality of channels that have completed the second standing, at the third temperature T3.

In the controlling method of a charging and discharging device of the present disclosure, each step of the charging-and-discharging S20 is initiated simultaneously in the plurality of channels. This does not mean that each step of the charging-and-discharging S20 is initiated first in only one of the plurality of channels. Through this, the charging/discharging imbalance of secondary batteries caused by the different end points of individual charging/discharging processes can be resolved.

In the above charging/discharging process, “standing” literally means allowing each channel to stand at a specific temperature. In other words, when there is a standing process between individual charging/discharging processes, each charging/discharging can be initiated simultaneously.

In one embodiment, charging in the charging-and-discharging S20 may be carried out at a constant current-constant voltage (CCCV). This is because the performance difference of secondary batteries can be confirmed through charging only when charging is performed under constant conditions.

In one embodiment, the charging-and-discharging S20 may be carried out at a constant current (CC). This is because the performance difference of secondary batteries can be confirmed through discharging only when discharging is performed under constant conditions.

In one embodiment, the first temperature T1 to the third temperature T3 may be the same or different from each other. Preferably, the first temperature T1 to the third temperature T3 may be different from each other. This is because simultaneous initiation of individual steps of the charging-and-discharging S20 can be meaningful only when the first temperature T1 to the third temperature T3 are different from each other.

In one embodiment, the first temperature T1 and the second temperature T2 may be different, and the second temperature T2 and the third temperature T3 may be different, but the first temperature T1 and the third temperature T3 may be the same.

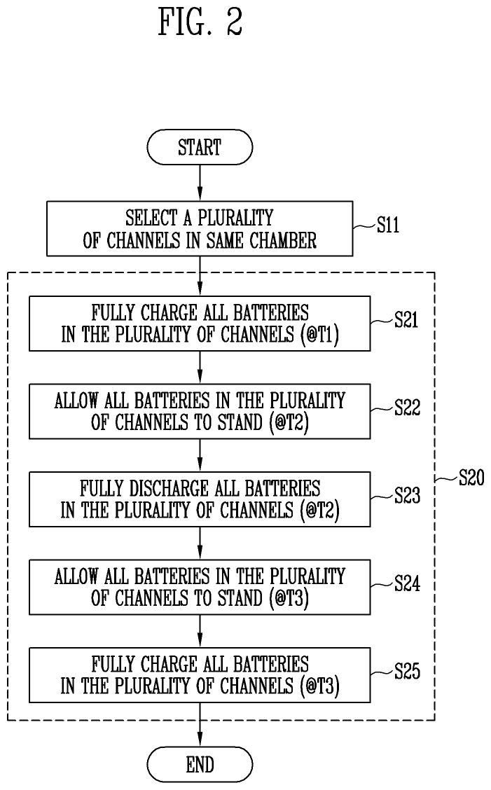

Reference is made to FIG. 2. In one embodiment, the selecting a plurality of channels may further include selecting S11 the plurality of channels within a same chamber. Specifically, in the selecting a plurality of channels, the plurality of channels within a same chamber may be selected so that the charging-and-discharging S20 is carried out in the plurality of channels within a same chamber.

When the selected plurality of channels are in different chambers, when each step of the charging-and-discharging S20 is initiated simultaneously, unnecessary delay may occur in each step. This is because the temperature of any one channel does not affect the temperature of another channel. When the selected plurality of channels are in a same chamber, the charging-and-discharging S20 may be more advantageous.

FIGS. 5 and 6 show flowcharts of selecting S10, S11 a plurality of channels in embodiments of the present disclosure.

Reference is made to FIG. 5. In one embodiment, when the selecting a plurality of channels includes

selecting the plurality of channels within a same unit S10, if the selected plurality of channels are within a same unit, the charging-and-discharging S20 is carried out in the same unit.

When the selected plurality of channels are not within a same unit, the charging/discharging process may be carried out for each unit. That is, as described above, when a plurality of channels in different units are selected, the charging/discharging process may be carried out for each unit.

Reference is made to FIG. 6. Even when the selected plurality of channels are within a same unit, the channels may be within different chambers. In one embodiment, when the selecting a plurality of channels further includes selecting the plurality of channels within a same chamber S11, when the selected plurality of channels are within a same chamber, the charging-and-discharging S20 may be carried out in the same chamber. Meanwhile, when the selected plurality of channels are not in the same chamber, the charging/discharging process may be performed for each chamber. That is, when a plurality of channels in different chambers are selected, the charging/discharging process may be carried out for each chamber.

In one embodiment, each step of the charging-and-discharging S20 may be carried out (initiation and ending) simultaneously in the plurality of channels.

Reference is made to FIG. 7. FIG. 7 shows a flowchart of first charging S21 and first standing S22 of an embodiment of the present disclosure. Specifically, the first charging S21 may end simultaneously in the plurality of channels. More specifically, the first charging 21 may include waiting for allowing a channel in which a secondary battery is fully charged to wait until all secondary batteries connected to the plurality of channels are fully charged. More specifically, the first charging S21 may include waiting for allowing a channel in which a secondary battery is fully charged to wait until charging is completed in channels in which secondary batteries have not been fully charged, when not all secondary batteries connected to the plurality of channels are fully charged. When charging of all secondary batteries of the plurality of channels is completed, first standing S22 may be simultaneously initiated in the plurality of channels.

Reference is made to FIG. 9. FIG. 9 shows a flowchart of first discharging S23 and second standing S24 of an embodiment of the present disclosure. Specifically, the first discharging S23 may end simultaneously in the plurality of channels. More specifically, the first discharging S23 may include waiting for allowing a channel in which a secondary battery is fully discharged to wait until all secondary batteries connected to the plurality of channels are fully discharged. More specifically, the first discharging S23 may include waiting for allowing a channel in which a secondary battery is fully discharged to wait until discharging is completed in channels in which secondary batteries have not been fully discharged, when not all secondary batteries connected to the plurality of channels are fully discharged. When discharging of all secondary batteries of the plurality of channels is completed, second standing S24 may be simultaneously initiated in the plurality of channels.

Reference is made to FIG. 11A and FIG. 11B show a flowchart of second charging S25 of an embodiment of the present disclosure. FIG. 11A shows a flowchart of a case in which second charging S25 ends simultaneously. FIG. 11B shows a flowchart of a case in which second charging S25 ends at different times (This will be described later). Specifically, the second charging S25 may end simultaneously in the plurality of channels. More specifically, the second charging 25 may include waiting for allowing a channel in which a secondary battery is fully charged to wait until all secondary batteries connected to the plurality of channels are fully charged. More specifically, the second charging 25 may include waiting for allowing a channel in which a secondary battery is fully charged to wait until charging is completed in channels in which secondary batteries have not been fully charged, when not all secondary batteries connected to the plurality of channels are fully charged. When charging of all secondary batteries of the plurality of channels is completed, the entire charging/discharging process may end.

In one embodiment, the controlling method of a charging and discharging device of the present disclosure may allow each channel to simultaneously initiate only a step in which there is a change in temperature among each step of charging-and-discharging S20. This is more desirable in terms of reducing unnecessary standing steps.

In one embodiment, the controlling method of a charging and discharging device of the present disclosure may further include determining S00 a temperature change step. The determining S00 a temperature change step may determine whether the first temperature T1 and the second temperature T2 are the same and whether the second temperature T2 and the third temperature T3 are the same in the charging-and-discharging S20 by analyzing the temperature at which each step of the charging-and-discharging S20 is carried out. It may be sufficient if this determining S00 a temperature change step is carried out before charging-and-discharging S20.

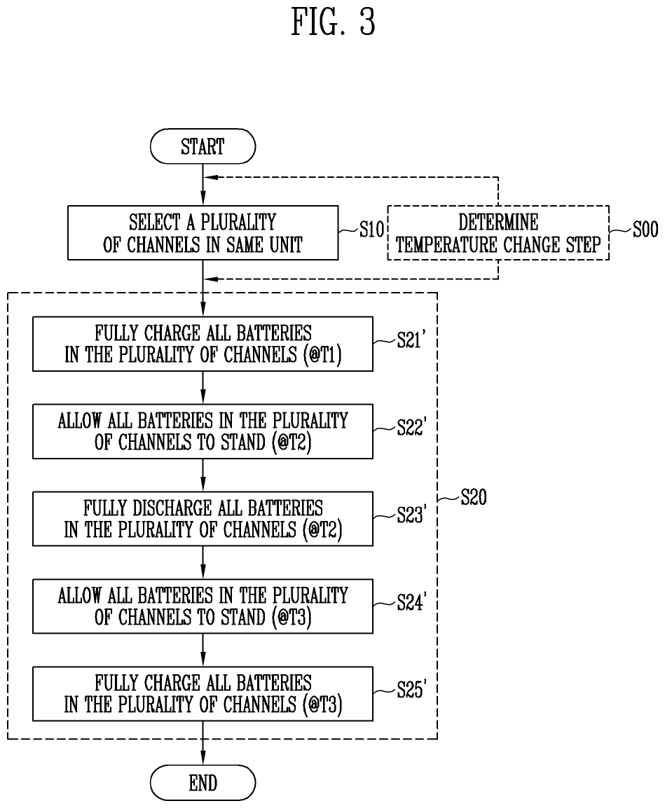

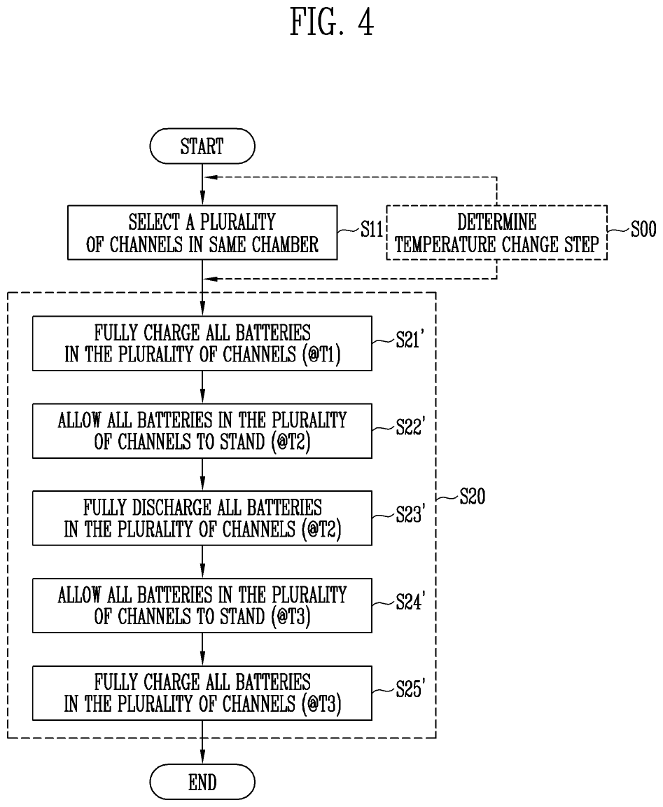

Reference is made to FIGS. 3 and 4. FIG. 3 shows a flowchart when selecting the plurality of channels includes selecting a plurality of channels in a same unit, and determining a temperature change step is carried out. FIG. 4 shows a flowchart when selecting the plurality of channels includes selecting a plurality of channels in a same chamber, and determining the temperature change step is carried out.

As a result of carrying out the determining a temperature change stage, each step of charging-and-discharging S20 may be carried out differently from before undergoing the determining a temperature change stage (Here, a prime (′) is added to the sign of each stage).

In one embodiment, the first temperature T1 and the second temperature T2 may be different. At this time, the first standing S22′ may be initiated simultaneously in the plurality of channels. Reference is made to FIG. 8. FIG. 8 shows a flowchart of first charging S21′ and first standing S22′ at this time. At this time, the first charging S21′ may end simultaneously in the plurality of channels. Specifically, the first temperature T1 and the second temperature T2 may be different, and this time, the first charging S21′ may include waiting for allowing a channel in which a secondary battery is fully charged to wait until all secondary batteries connected to the plurality of channels are fully charged. More specifically, the first temperature T1 and the second temperature T2 may be different, and the first charging S21′ may include waiting for allowing a channel in which a secondary battery is fully charged to wait until charging is completed in channels in which secondary batteries have not been fully charged, when not all secondary batteries connected to the plurality of channels are fully charged. As a result, the first standing S22′ may be simultaneously initiated in the plurality of channels.

In one embodiment, the second temperature T2 and the third temperature T3 may be different. At this time, the second standing S24′ may be initiated simultaneously in the plurality of channels. Reference is made to FIG. 10. FIG. 10 shows a flowchart of first discharging S23′ and second standing S24′ at this time. At this time, the first discharging S23′ may end simultaneously in the plurality of channels. Specifically, the second temperature T2 and the third temperature T3 may be different, and at this time, the first discharging S23′ may include waiting for allowing a channel in which a secondary battery is fully discharged to wait until all secondary batteries connected to the plurality of channels are fully discharged. More specifically, the second temperature T2 and the third temperature T3 may be different, and at this time, the first discharging S23′ may include waiting for allowing a channel in which a secondary battery is fully discharged to wait until discharging is completed in channels in which secondary batteries have not been fully discharged, when not all secondary batteries connected to the plurality of channels are fully discharged. As a result, the second standing S24′ may be simultaneously initiated in the plurality of channels.

In one embodiment, the second charging S25′ may end at different times in the plurality of channels. FIG. 11B shows a flowchart of second charging S25′ according to an embodiment of the present disclosure. Specifically, FIG. 11B shows a flowchart of second charging S25′ when the second charging S25′ ends at different times in the plurality of channels. At this time, the second charging S25′ may be carried out independently in the plurality of channels. Therefore, when the second charging S25′ is completed in any one channel, the charging/discharging process of that channel may end. In addition, since the second charging S25′ is carried out independently in the plurality of channels, the charging/discharging process in each channel may end simultaneously in some cases.

In the present disclosure, the charging-and-discharging S20 may further include an additional process in addition to each of the above processes. In other words, when the conditions stipulated in the present disclosure are met, the charging-and-discharging S20 may further include other charging, discharging and/or standing steps between the first charging and the second charging.

The content described above is merely an example of applying the principles of the present disclosure, and other features may be further included without departing from the scope of the present invention.

What is claimed is:

1. A controlling method of a charging and discharging device, using a charging and discharging device including a plurality of units, wherein the units include a plurality of chambers accommodated in the units, wherein the chambers include a plurality of channels accommodated in the chambers, and wherein the channels charge or discharge secondary batteries, comprising:
selecting a plurality of channels, each of which is connected to a secondary battery; and
charging-and-discharging each of the secondary batteries connected to the selected plurality of channels,
wherein the selecting a plurality of channels includes selecting the plurality of channels in a same unit, and
wherein the charging-and-discharging includes:
first charging for fully charging all secondary batteries connected to the plurality of channels at a first temperature;
first standing for allowing all the secondary batteries connected to the plurality of channels that have completed the first charging to stand at a second temperature;
first discharging for fully discharging all the secondary batteries connected to the plurality of channels that have completed the first standing, at the second temperature;
second standing for allowing all the secondary batteries connected to the plurality of channels that have completed the first discharging to stand at a third temperature; and
second charging for fully charging all the secondary batteries connected to the plurality of channels that have completed the second standing, at the third temperature,
wherein each step of the charging-and-discharging is simultaneously initiated in the plurality of channels.

2. The controlling method of a charging and discharging device according to claim 1, wherein the selecting a plurality of channels further includes selecting the plurality of channels in a same chamber.

3. The controlling method of a charging and discharging device according to claim 1, wherein the first charging ends simultaneously in the plurality of channels.

4. The controlling method of a charging and discharging device according to claim 1, wherein the first discharging ends simultaneously in the plurality of channels.

5. The controlling method of a charging and discharging device according to claim 1, wherein the second charging ends simultaneously in the plurality of channels.

6. The controlling method of a charging and discharging device according to claim 1, further comprising: determining a temperature change step for determining whether the first temperature and the second temperature are the same and whether the second temperature and the third temperature are the same in the charging-and-discharging by analyzing the temperature at which each step of the charging-and-discharging is carried out.

7. The controlling method of a charging and discharging device according to claim 6, wherein the first temperature is different from the second temperature, and the first standing is initiated simultaneously in the plurality of channels.

8. The controlling method of a charging and discharging device according to claim 7, wherein the first charging ends simultaneously in the plurality of channels.

9. The controlling method of a charging and discharging device according to claim 6, wherein the second temperature is different from the third temperature, and the second standing is initiated simultaneously in the plurality of channels.

10. The controlling method of a charging and discharging device according to claim 9, wherein the first discharging ends simultaneously in the plurality of channels.

11. The controlling method of a charging and discharging device according to claim 6, wherein the second charging ends at different times in the plurality of channels.

12. The controlling method of a charging and discharging device according to claim 11, wherein the second charging is independently carried out in the plurality of channels.
